(19) United States
(12) Patent Application Publication
(10) Pub. No.: US 2002/0174697 A1
(43) Pub. Date: Nov. 28, 2002

(54) Micronized plant/soil amendment

(76) Inventors: Bruce Reid, Placitas, NM (US); Michael Karr, Monte Vista, CO (US)

Correspondence Address: PEACOCK MYERS AND ADAMS P C, P O BOX 26927, ALBUQUERQUE, NM, 871256927

(21) Appl. No.: 09/788,057

(22) Filed: Feb. 16, 2001

(51) Int. Cl. C05F 11/00

(52) U.S. Cl. 71/23

(57) ABSTRACT

The present invention comprises a dry composition of a plant and/or soil amendment and a suspending agent, a liquid composition created therefrom and a method of making and using the same.

### BACKGROUND OF THE INVENTION

1. Field of the Invention (Technical Field)

The present invention relates to dry compositions and suspensions thereof comprising, for example, materials that benefit soils and/or plants, such materials optionally comprising naturally occurring materials.

2. Background Art

Note that the following discussion refers to a number of references and/or publications by author(s) and year of publication. In some instances, due to recent publication dates, certain publications are not to be considered as prior art vis-a-vis the present invention. Discussion of such references and/or publications herein is given for more complete background and is not to be construed as an admission that such publications are prior art for patentability determination purposes or that certain references are in fact publications.

The following references and/or publications discuss amendments and other materials for plants and/or soils: Aitken, J. B., B. Acock, and T. L. Senn, “The characteristics and effects of humic acids derived from leonardite,” Technical Bulletin 1015: South Carolina Agricultural Experiment Station, Clemson University, Clemson, S.C.; Bohn, H., McNeal, B. and G. O'Connor, Soil Chemistry, 2nd ed., pp. 143-147, Wiley & Sons, New York (1985); Casper, M. S., Liquid Fertilizers, Noyes Data Corporation, Park Ridge N.J., pp.72-74, 145-167 (1973); Davies, G. and E. Ghabbour, eds., Humic Substances, Structures, Properties and Uses, pp. 1-24, 79-91 (1998); Dinauer, R. C., ed., Minerals in Soil Environments, Soil Science Society of America, Madison, Wis., pp. 435-465 (1977); Freeman, P. G., and W. W. Fowles, Coal-Derived Humus Plant Growth Effects, US Dept. of Interior Bureau of Mines Report of Investigations 7203; MacCarthy, P., Clapp, C., Malolm, R., and P. Bloom, eds., Humic Substances in Soil and Crop Sciences, Selected Readings, pp. 261-273, American Society of Agronomy, Inc., Madison, Wis. (1990); Sposito, G., The Chemistry of Soils, pp.42-66, Oxford University Press, New York (1989); Stevenson, F. J., Humus Chemistry, Genesis, Composition, Reactions, 2nd ed., pp. 367-373, John Wiley & Sons, Inc. New York (1994).

The following U.S. Patent discusses amendments and other materials for plants and/or soils:

U.S. Pat. No. 4,069,034, entitled “Suspension fertilizers and method of producing same,” to Hoover, issued Jan. 17, 1978, ('034 Patent) discloses use of humic acid as a crystallization inhibitor and crystal growth modifier wherein humic acid content ranges from 0.05% to 3% by weight. As disclosed, humic acid retards formation and growth of phosphate fertilizer crystals/salts, which is purportedly advantageous because “growth of crystals may cause stoppage of spray nozzles in application and may cause settling of the crystals.” Further disclosed is the use of 1% to 3% by weight of clay to increase viscosity, which in turn, “delays settling and crystal growth, and keeps the solids from forming a hard cake when settling eventually occurs.” Thus, the '034 Patent relies on solely on liquid humic acid, as retardant of phosphate crystal formation, and fails to recognize that sources of humic acids, such as oxidized lignite, which contains non-extracted humic acids, also contains useful nutrients, improves soil properties, increases plant availability of stored soil nutrients, and stimulates the growth of plants. The '034 Patent does not address the issue of delivering high concentrations of oxidized lignite and other naturally-occurring materials of benefit to soils and vegetation.

To date no existing liquid product contains high levels of the humic and fulvic acids shown to stimulate plant growth and enhance soil nutrient availability. The aforementioned references and/or publications disclose the benefits realized by the application of oxidized lignite and other humates to plants and soils. Many of these treatments, however, rely on base extraction of humic and/or fulvic acids (see, e.g., '034 Patent), which achieve a meager humic acid plus fulvic acid content of about 6% by weight at a pH of about 9. These prevailing base-extraction methods, and compositions thereof, teach that more base results in more available humic acid content. Thus, some have added high amounts of base, which generally results in a high pH product, for example, even at a pH of 12, content of humic and/or fulvic acid rarely exceeds 12%. Accordingly, the amount of humic acid plus fulvic acid that can be applied to soils via existing liquid products is only 0.5 lb to 1 lb per gallon (0.06 to 0.12 kg/liter).

To realize both soil and plant benefits from soil applied humic plus fulvic acids, a level of at least 40 lbs per acre (44.8 kg per hectare) of high quality oxidized lignite (or other humate which contains at least 70% extractable humic plus fulvic acids) must be achieved, and a much higher level is required for maximum economic benefit, for example, from at least approximately 100 kg oxidized lignite per hectare to approximately 500 kg oxidized lignite per hectare. Thus, liquid forms are generally too expensive and/or bulky to use.

Regarding liquid forms, reagents, extraction and stabilization processing, capital equipment requirements, transportation, storage and application costs are prohibitively high. Therefore, repeated foliar applications of liquid humic plus fulvic acids are usually recommended, at rates ranging from 1 to 3 gallons per acre (10 to 28 liters/ha), which would supply 0.4 to 3 lb of humic plus fulvic acids per acre (0.5 to 3.4 kg /ha), at least three times over the growing season, to achieve discernable benefits for plants. However, this amount is too low to provide any substantial or readily measurable benefits for soils.

To date, none of the commercially available liquid extracts of oxidized lignites and other sources of humic acids are approved by the Organic Materials Review Institute (OMRI), of Eugene, Oreg. Approval has been denied due to the use of certain chemicals used in the humate extraction process. The use of harsh chemicals also increases toxicity and handling hazards of the liquid extracts to users, especially at high, caustic pH. Neutral salts like sodium pyrophosphate pose an alternative to harsh chemicals; however, such salts are less effective and typically extract only one-half to two-thirds of the humic and fulvic acids when compared to a strong base. Further, because sodium pyrophosphate is not a naturally occurring mineral, it would not be approved as an “organic” extracting agent by OMRI. Naturally occurring sodium carbonate compounds, for example, Na₃H(CO₃)₂ (known as “trona”), could perhaps be submitted for approval, but sodium is not a plant nutrient and will act to detrimentally disperse soil aggregates. Water as an extractant may be another suitable alternative from an “organic” perspective; however, amounts of humic and fulvic acids extracted into solution by water alone are generally less than 20% of the humic and fulvic acids present in oxidized lignite, and resulting solution concentrations of humic and fulvic acids would most likely be less than 3%.

Commercially available products containing humic plus fulvic acids include liquid humic plus fulvic acid extracts; dry oxidized lignites, peats and other humic acid containing materials, dried down water-soluble humic plus fulvic acid extracts; and oxidized lignites sprayed with an alkaline extracting chemical and dried. Liquid humic acid products generally contain between 6% humic and fulvic acids by weight at a pH 9 and 12% humic and fulvic acids by weight at pH 12. Potassium hydroxide is generally used as the chemical extractant, although, aqueous ammonia or anhydrous ammonia are also used by some manufacturers. Chief limitations of liquid extracts are high cost (extraction costs, plus hauling and storing a product that is at least 88% water), causticity/corrosiveness due to high pH, and the need to apply very large volumes (e.g., generally need to apply over 25 gallons per acre (over 235 liters per hectare) to significantly enhance soil physical and chemical properties). Smaller volumes (10 to 30 liters per hectare) are effective as a foliar feed for plants, or these rates may be used to enhance nutrient availability of banded fertilizers, if mixed into the band. However, nutrient availability outside of the fertilizer band, as well as other soil physical and chemical properties, will not be affected at these low rates.

Dried water-soluble humic plus fulvic acid extracts are made by evaporating water from liquid humic plus fulvic acid products. The added cost associated with evaporating a product that is at least 88% water, must be compared with cost savings from not having to transport and/or store water. In addition, high rates of dilution or dilution with hard water often leaves significant precipitates (sludge), thus reducing overall effectiveness of such products.

For oxidized lignites and other humic acid sources coated with the alkaline extractant, the material is very caustic to handle or breathe. In addition, not all of the material will go into solution when rewetted, so the sludge must be separated and removed. The costs of the extractant and the process of coating and drying add to the cost of the finished product.

Generally liquid products are less expensive if purchased close to the plant where they are produced, while base coated or water soluble products are typically less expensive if shipped to distant locales.

Dry humate products provide for the lowest cost per pound of humic and fulvic acids. However, such products often lack visual appeal and present some dust problems. In addition, many growers, especially those who irrigate their crops, prefer that all inputs of fertilizer, pesticides and other products be applied in a liquid form, often with the irrigation water as a carrier.

Overall, a need exists for an organic product, which is applicable in a liquid form and contains high concentrations of humate or other valuable plant and/or soil nutrients. Various embodiments of the present invention address this need.

### SUMMARY OF THE INVENTION (DISCLOSURE OF THE INVENTION)

The present invention comprises compositions and methods of making and using the same. In one embodiment, the present invention comprises a substantially dry composition for application to plants or soils, said composition comprising: at least one micronized amendment; and a suspending agent. According to this embodiment, the at least one amendment optionally comprises oxidized lignite, gypsum, limestone, rock phosphate and/or mixtures thereof. While more than one suspending agent is optionally used, the suspending agent of this embodiment optionally comprises attapulgite clay. The suspending agent of this embodiment optionally comprises an agent that forms a thixotrophic suspension when mixed with water. In this embodiment, the at least one micronized amendment optionally comprises organic material and/or the suspending agent optionally comprises organic material. In this embodiment, the at least one micronized amendment and the suspending agent optionally each consist of organic material, such that the composition consists of organic material. This embodiment optionally further comprises at least one surfactant, wherein the at least one surfactant optionally comprises Yucca extract.

In another embodiment, the present invention comprises a suspension for application to plants or soils, said suspension comprising: at least one micronized amendment; a suspending agent; and water, wherein said water, said at least one micronized amendment and said suspending agent form a suspension. In this embodiment, the at least one micronized amendment optionally comprises oxidized lignite, gypsum, limestone, rock phosphate and/or combinations thereof. While more than one suspending agent is optionally used, the suspending agent of this embodiment optionally comprises attapulgite clay. The suspending agent of this embodiment optionally comprises an agent that forms a thixotrophic suspension when mixed with water. In this embodiment, the at least one micronized amendment optionally comprises organic material and/or the suspending agent optionally comprises organic material. In this embodiment, the at least one micronized amendment and the suspending agent optionally each consist of organic material, such that the suspension consists of organic material. This embodiment optionally further comprises at least one surfactant, wherein the at least one surfactant optionally comprises Yucca extract.

In yet another embodiment, the present invention comprises a method of making a substantially dry composition capable of forming a liquid suspension for application to plants or soils, the method comprising the steps of: providing an amendment; providing a suspending agent; and micronizing the amendment and the suspending agent. According to this embodiment, the amendment optionally comprises oxidized lignite, gypsum, limestone, rock phosphate and/or combinations thereof. While more than one suspending agent is optionally used, the suspending agent of this embodiment optionally comprises attapulgite clay. The suspending agent of this embodiment optionally comprises an agent that forms a thixotrophic suspension when mixed with water. In this embodiment, the at least one micronized amendment optionally comprises organic material and/or the suspending agent optionally comprises organic material. In this embodiment, the at least one micronized amendment and the suspending agent optionally each consist of organic material, such that the composition consists of organic material. This embodiment optionally further comprises at least one surfactant, wherein the at least one surfactant optionally comprises Yucca extract.

In one embodiment, the present invention comprises a method of making a suspension for application to plants or soils, the method comprising the steps of: providing an amendment; providing a suspending agent; micronizing the amendment and the suspending agent to form a micronized mix; and mixing the micronized mix with water to form a suspension. According to this embodiment, the amendment optionally comprises oxidized lignite, gypsum, limestone, rock phosphate and/or combinations thereof. While more than one suspending agent is optionally used, the suspending agent of this embodiment optionally comprises attapulgite clay. The suspending agent of this embodiment optionally comprises an agent that forms a thixotrophic suspension when mixed with water. In this embodiment, the at least one micronized amendment optionally comprises organic material and/or the suspending agent optionally comprises organic material. In this embodiment, the at least one micronized amendment and the suspending agent optionally each consist of organic material, such that the suspension consists of organic material. This embodiment optionally further comprises at least one surfactant, wherein the at least one surfactant optionally comprises Yucca extract.

A primary object of the present invention is to effectively make and/or deliver amendments to plants and/or soils.

A primary advantage of the present invention is effective making of and/or delivery of amendments to plants and/or soils.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a plot of top weight data (composite from 8 trials) as a percent of Control versus treatment;

FIG. 2 is a plot of fresh root weight data (composite from 8 trials) as a percent of Control versus treatment;

FIG. 3 is a plot of total uptake of elements (composite of 12 elements from 8 trials) as a percent of Control versus treatment;

FIG. 4 is a photograph showing a comparison between a suspension according to an embodiment of the present invention comprising 35% micronized gypsum with 1.5% by weight attapulgite clay as a suspending agent and 35% micronized gypsum without the suspending agent after 24 hours of settling;

FIG. 5 is a photograph showing a comparison between a suspension according to an embodiment of the present invention comprising 35% micronized limestone with 2.5% by weight attapulgite clay as a suspending agent and 35% micronized limestone without the suspending agent after 24 hours of settling;

FIG. 6 is a photograph showing a comparison between a suspension according to an embodiment of the present invention comprising 35% micronized rock phosphate with 2.5% by weight attapulgite clay as a suspending agent and 35% micronized rock phosphate without the suspending agent after 24 hours of settling;

FIG. 7 is a photograph showing a comparison between the growth of corn soil-treated with micronized suspension of oxidized lignite to a control without added oxidized lignite. The control is on the left. All treatments received full fertilizer inputs prior to planting;

FIG. 8 is a photograph showing a comparison between the growth of corn foliar-treated with micronized suspension of oxidized lignite to a control without added oxidized lignite. The control is on the left;

FIG. 9 is a photograph showing a comparison between the growth of sunflowers soil-treated with micronized suspension of oxidized lignite to a control without added oxidized lignite. All treatments received full fertilizer inputs prior to planting. The control is on the left; and

FIG. 10 is a photograph showing a comparison between the growth of sunflowers foliar-treated with micronized suspension of oxidized lignite to a control without added oxidized lignite. The control is on the left.

### DESCRIPTION OF THE PREFERRED EMBODIMENTS

### (Best Modes for Carrying out the Invention)

The present invention comprises compositions containing high concentrations of soil and/or plant amendments and methods of making the same. According to one embodiment, the amendment comprises oxidized lignite, as a rich source of humic plus fulvic acids is “micronized” and combined with a suspending agent, to form a oxidized lignite-suspension mix. For a mix comprising substantially dry, micronized oxidized lignite and a substantially dry suspending agent, subsequent addition of water to the mix creates a highly concentrated oxidized lignite suspension suitable for application to vegetation or soils via traditional means known to one of ordinary skill in the agricultural arts. The so-called “dry mix” (or substantially dry) of this embodiment is easily transported, handled and turned into a liquid soil and plant amendment, generally by hand and/or mechanized mixing or stirring, i.e., mixing achieved through addition of water alone, e.g., a garden hose, and optionally hand stirring. Of course, larger volumes (e.g., greater than approximately 100 liters) are optionally mixed through mechanized mixing/stirring techniques known in the art.

According to one liquid suspension embodiment, a beneficial level of amendment, e.g., oxidized lignite, is applied, for example, approximately 40 lbs of 70% humic plus fulvic acids grade per acre. In this embodiment, approximately 14 gallons would be needed per acre whereas, using traditional base-extracted humic plus fulvic acid liquids, 28 to 56 gallons would be needed per acre.

In another embodiment, the amendment, e.g., oxidized lignite, is micronized and combined with a suspending agent and water to immediately form a liquid plant and soil amendment. According to this embodiment, the suspending agent provides for shelf-stability and ease of re-suspension should any significant degree of settling occur. In general, re-suspension is achieved simply by stirring or hand-shaking a container containing the composition. Of course, for large containers not amenable to hand-shaking, low shear shaking, stirring, etc., are suitable to re-suspend the particulate contents of the composition.

Results presented herein demonstrate that compositions of the present invention have excellent performance characteristics when compared to other commercially available amendments, which include, for example, humic acid and/or fulvic acid. For example, as presented herein, results from 8 experiments, using 4 different crops, each on two different soils indicated that benefits to plants from foliar-applied micronized oxidized lignite combined with a suspending agent, are equal to or greater than benefits from liquid humate extracts on a per-gallon basis. Benefits of soil-applied micronized and suspended oxidized lignite to plants are also equal to, or greater than equivalent amounts of soil-applied oxidized lignite.

The following terms are used herein:

Soil and/or Plant Amendment. A plant and/or soil amendment, or “amendment,” as used herein comprises any porous, solid or liquid material, or combination thereof, that is applied to any surface of the plant, to achieve some benefit to the plant. Such benefits include, but are not limited to, growth stimulation, disease mitigation or suppression, nutrition, stress tolerance, protection against or increased tolerance to adverse environmental conditions. The term “amendment” also comprises any porous, solid or liquid material, or combination thereof, such as lime, gypsum, sawdust, compost, compost tea, solid or liquid animal manures, crop residues, humates etc. that is worked into the soil or applied on the surface, or placed in a band on the surface or in a band into the soil to enhance plant growth, or to enhance soil properties that indirectly enhance plant growth. Amendments include, but are not limited to, oxidized lignite, gypsum, rock phosphate, and limestone.

Oxidized Lignite. The oxidized lignite employed in various embodiments of the present invention as an amendment, comprises, for example, but is not limited to, any lignite or brown coal of a variety of coal intermediate between peat and bituminous coal. The chemical composition and characteristic of lignite have been described in literature, for example Encyclopedia of Chemical Technology, Volume 14, Kirk-Othmer, and the Journal of American Chemical Society, Volume 69 (1947). Lignite is often referred to “brown coal”, or “wood coal” since the texture of the original wood is distinct.

The Encyclopedia of Chemical Technology (Vol. 14) by Kirk-Othmer points out that lignite is distinguishable from lignin. Lignin is a complex noncarbohydrate constituent obtained from wood, straw, corn stocks, or the like, and is substantially different chemically from the coal matter, lignite.

The lignitic material of various embodiments of the present invention preferably contain appreciable quantities of humic and fulvic acids. The richest common source of humic and fulvic acids is the material known as oxidized lignite, which is generally a dark brown to black carbonaceous form of lignite. Leonardite, refers to a particular deposit of oxidized lignite which occurs in North Dakota. “Leonardite” is, at times, misused in place of the broader term, oxidized lignite, which includes other deposits occurring in several areas of the world. According to an embodiment of the present invention, oxidized lignite, which normally contains from approximately 20% to approximately 50% moisture is used or, alternatively, ground and dried to less than approximately 20% moisture. Oxidized lignite in its natural form has few humic acid and fulvic acid components that are soluble in water alone. These components typically become increasingly soluble as pH levels rise above the material's natural pH (e.g., pH of approximately 3.3 to approximately 4.0). Thus, oxidized lignite is dissolvable naturally in higher pH environments, such as those often found in soils and on plant leaf surfaces. Water-soluble salts of humic acids and fulvic acids are readily producable by treating oxidized lignite with sufficient aqueous alkali to neutralize hydrogen bonds. These treated materials are then optionally evaporated to a desired moisture level to form, for example, a dry powder. The base insoluble materials that remain are inorganic impurities and humin. Soluble extracts of oxidized lignite are also possible by mixing oxidized lignite into aqueous alkaline solutions, such as solutions of KOH and water.

The humate material used in the various embodiments of the present invention preferably comprises at least approximately 35 wt. % on a dry weight basis of humic plus fulvic acids and their salts. More preferably, the oxidized lignitic material employed in the present invention comprises from about 55% to about 80 wt. % on a dry weight basis of humic plus fulvic acids. Because of the variable nature of oxidized lignite, and other naturally occurring humic plus fulvic acid containing materials, a precise molecular structure of oxidized lignite is unknown. However, these materials (and humic acid) are well known to skilled artisans, and are available commercially.

Leonardite. Leonardite is actually a particular deposit of oxidized lignite in North Dakota; however, the mining and agricultural industry often uses the term “leonardite” in place of “oxidized lignite,” which is technically more accurate. The term “leonardite,” as used herein, refers to that particular deposit of oxidized lignite.

Humate. Humate is a blanket term used by the agricultural industry for any material used as a source of humic and fulvic acids. These materials include oxidized lignites, lignosulfonates, low energy coals, peat, organic soils, composted materials, organic marine and aquatic sediments, and organic surface layers of soils. The methods and/or processes of micronizing and/or suspending any of these sources of humic and fulvic acids to make compositions, as described in various embodiments of the present invention, is within the scope of the present invention. The term “humate”, as used herein, refers to any source of humic and fulvic acids, which includes and is broader than salts of humic acid.

Humin. Humin comprises the portion of humate that is not soluble in acidic or basic solutions. Liquid extracts of oxidized lignite and/or other humic plus fulvic acid containing materials do not include humin. Humin has soil amendment properties, for example, humin holds water, absorbs fat-soluble compounds and reduces leaching of plant nutrient elements. Humin is usually black in color.

Humic acid. Humic acid comprises the portion of humate or soil humus that is soluble in 0.5N NaOH, but not soluble in an acid solution with a pH of less than 2.0. Humic acid is typically dark brown to black in color.

Fulvic acid. Fulvic acid comprises the portion of humate or soil humus that is soluble in both alkaline and acid solutions. Fulvic acid is usually light yellow to yellow-brown in color.

Dry, water-soluble humate. Dry, water-soluble humate comprises humic and fulvic acids extracted from raw oxidized lignite or other humic and fulvic acid containing material using a base, e.g., potassium hydroxide, followed by dewatering, e.g., evaporation.

Gypsum. The term “gypsum,” as used herein, comprises all mineral forms of calcium sulfate, with or without waters of hydration. These mineral forms comprise natural deposits of rock, a sand, or as a chemical product or by-product of industry. Excluded from this definition are synthetically produced fertilizers or fertilizer blends where various forms of calcium sulfate are used as fillers.

Limestone. The term “limestone,” as used herein, comprises all mineral forms of calcium carbonates and magnesium carbonates, or mixtures of both, with or without waters of hydration. Limestone comprises naturally occurring forms such as, but not limited to limestone rock or sediment, dolomitic rock or sediments, marl, oyster shells, and other rocks or sediments containing calcium carbonates and/or magnesium carbonates mixed with other minerals. Included in the term “limestone” are other materials containing calcium carbonate and/or magnesium carbonate produced as reaction products by industry. Excluded from this definition are synthetically produced fertilizers or fertilizer blends where various forms of calcium carbonates are used as fillers.

Rock Phosphate. The term “rock phosphate,” as used herein, comprises natural mineral deposits containing chiefly calcium phosphates, but also includes other forms of calcium phosphates found in nature such as bones and teeth, and other natural forms of calcium phosphates, such as bone meal. According to certain embodiments, this term excludes all acidulated forms of calcium phosphates, whether solid or liquid, which are industrially produced.

Salt Index. The term “salt index,” as used herein, comprises the ratio of osmotic pressure of a material in aqueous solution or soil solution, compared to an equal amount of sodium nitrate, based on a relative value of 100.

Micronize. Micronize (including “micronizing” and “micronized”) refers to a method or process of reduction of a material to a very fine powder, with the resulting particles being no larger than microscopic size, defined herein as having a particle size of 100% less than approximately 50 microns. It also refers as an adjective to material that exists in a state of having a particle size of 100% less than approximately 50 microns. Generally, the smaller the particle, the easier it is to suspend with a suspending agent. According to Stoke's Law, the settling velocity of a particle with a density greater than water is proportional to the square of the radius of the particle. In one embodiment of this invention, the fine grinding was performed using an attrition-type, high-velocity mill; but includes the grinding of a material to 100% less than 50 microns using other methods and/or machinery. The term “micronize,” as used herein, generally refers to the process of grinding a material down to a particle size of 100% less than approximately 50 microns. In some instances, a material or an amendment is optionally found micronized in its natural state; thus, a “micronizing” step is optionally omitted. The term “micronize” includes these materials that exist in a natural state at a particle size of 100% less than approximately 50 microns. Such materials are optionally available through separation techniques known to one of ordinary skill in the art. Blasting of materials, in a natural or other state, is also a method that is optionally used to render micronized materials.

Naturally Occurring. The term “naturally occurring,” as used herein, refers to materials or chemical compositions that are found in nature, or result from natural processes. Industrially synthesized materials or chemical compositions, with the exception of materials or chemical compositions that are also found in nature, are excluded.

Organic. The term “organic,” as used herein, generally refers to its use as an agricultural term, which is a method of farming or gardening without the use of industrially produced synthetic pesticides or fertilizers.

Organic Certification. The term “organic certification,” which includes “organically certified” as used herein, refers to the approval of a material that meets organic specifications or guidelines by any recognized local, state, national or international government, private or non-profit board or organization.

Suspension. A suspension comprises solids suspended in a liquid, for example, finely ground oxidized lignite solids suspended in water. Any significant settling of the solids is retarded by, for example, Brownian motion and/or hydration, which can alter the effective density of the solids. In addition, suspending agents, or structuring agents, are effective for preventing and/or hindering settling of solids. In general, according to various embodiments of the present invention, the solids do not completely settle out due to size, large hydrated radius and/or random stacking or structuring of the solids or added suspending agents, which include, but are not limited to, attapulgite clay.

Suspending agent. As disclosed herein, a suspending agent comprises any material or materials suitable for mixing with an aqueous liquid to provide rheological properties sufficient to suspend amendments (whether, e.g., solid and/or porous particles) of the present invention. The most common suspending or thickening agents are clays, but materials such as colloidal silica, particulate polymers, such as polystyrene and oxidized polystyrene, combinations of certain surfactants, and water-soluble polymers such as polyacrylate are also known to provide rheological characteristics adequate to form suspensions. Where OMRI (organic) certification is a concern, “natural” materials are preferred; thus, for OMRI certification, the most preferred suspending agents are naturally occurring clays and/or gums, which may be certified as organic.

Naturally occurring clays include smectites and attapulgites. These colloidal materials can be described as expandable layered clays, i.e., aluminosilicates and magnesium silicates. The term “expandable” as used to describe the ability of the layered clay structure to be swollen, or expanded, on contact with water. The expandable clays used herein are those materials classified geologically as smectites (or montmorillonites) and attapulgites (or palygorskites).

Smectites are three-layered clays. There are two distinct classes of smectite-clays. In the first, aluminum oxide is present in the silicate crystal lattice; in the second class of smectites, magnesium oxide is present in the silicate crystal lattice. The general formulas of these smectites are Al₂(Si₂O₅)₂(OH)₂ and Mg₃(Si₂O₅)(OH)₂, for the aluminum and magnesium oxide type clays, respectively. It is to be recognized that the range of the water of hydration in the above formulas can vary with the processing to which the clay has been subjected. This is immaterial to the use of the smectite clays in the present compositions in that the expandable characteristics of the hydrated clays are dictated by the silicate lattice structure. Furthermore, atom substitution by iron and magnesium can occur within the crystal lattice of the smectites, while metal cations such as Na⁺ and Ca⁺⁺, as well as H⁺, can be copresent in the water of hydration to provide electrical neutrality. Such cation substitutions in general are immaterial to the use of the clays herein since the desirable physical properties of the clay are not substantially altered thereby.

The layered expandable aluminosilicate smectite clays useful herein are further characterized by a dioctahedral crystal lattice, whereas the expandable magnesium silicate clays have a trioctahedral crystal lattice.

The smectite clays used in the compositions herein are all commercially available. Such clays include for example, montmorillonite (bentonite), volchonskoite, nontronite, beidellite, hectorite, saponite, sauconite and vermiculite. The clays herein are available under commercial names such as “Fooler Clay” (clay found in a relatively thin vein above the main bentonite or montmorillonite veins in the Black Hills) and various trade names such as Thixogel No. 1 and Gelwhite GP from ECC America, Inc. (both montmorillonites); Volclay BC, Volclay No. 325, and especially Volcay HPM-20 from American Colloid Company, Skokie, Ill.; Black Hills Bentonite BH 450, from International Minerals and Chemicals; Veegum Pro and Veeghum F, from R. T. Vanderbilt (both hectorites); Barasym NAS-100, Barasym NAH-100, Barasym SMM 200, and Barasym LIH-200, all synthetic hectorites and saponites marketed by Baroid Division, NL, Industries, Inc.

A second type of expandable clay material useful in the instant invention is classified geologically as attapulgite (palygorskite). Attapulgites are magnesium-rich clays having principles of superposition of tetrahedral and octahedral unit cell elements different from the smectites. An idealized composition of the attapulgite unit cell is given as: (OH₂)₄(OH)₂Mg₅Si₈O₂₀4H₂O. A typical attapulgite analyses yields 55.02% SiO₂; 10.24% Al₂O₃; 3.53% Fe₂O₃; 10.45% MgO; 0.47% K₂O; 9.73% H₂O removal at 150 degree C.; 10.13% H₂O removed at higher temperatures.

Like the smectites, attapulgite clays are commercially available. For example, such clays are marketed under the tradename Attagel, i.e. Attagel 40, Attagel 50 and Attagel 150 from Engelhard Minerals & Chemicals Corporation; Min-U-Gel 400, Min-U-Gel LF from ITC Industrials Corporation.

According to certain embodiments of the present invention, mixtures of smectite and attapulgite clays are useful. In general, such mixed clay compositions exhibit increased and prolonged fluidity upon application of shear stress but are still adequately thickened solutions at times when flow is not desired. Clay mixtures in a smectite/attapulgite weight ratio of from 5:1 to 1:5 are preferred. Ratios of from 2:1 to 1:2 are more preferred.

As noted above, clays employed in various clay containing compositions of the present invention typically comprise cationic counter ions such as protons, sodium ions, potassium ions, calcium ions, magnesium ions and the like. It is customary to distinguish between clays on the basis of one cation, which is predominately or exclusively absorbed. For example, a sodium clay is one in which the absorbed cation is predominately sodium. Such absorbed cations can become involved in exchange reactions with cations present in aqueous solutions. In one embodiment, compositions optionally comprise up to about 12% or preferably up to about 8% potassium ions since they improve the viscosity increasing characteristics of the clay.

According to one embodiment of the present invention, the amount of clay, in a liquid composition, will normally be from about 0.25% to about 20%, preferably from about 0.5% to about 7%, more preferably from about 0.5% to about 3%.

Other suspending agents which are useful include colloidal silica having, for example, a mean particle diameter ranging from about 0.01 micron to about 0.05 micron; and polycarboxylate polymers, e.g., polyacrylates, polymethacrylates, etc. and copolymers of such monomers with other monomers such as ethylene, etc.

Still other suspending agents useful herein include organic, naturally derived types, such as, but not limited to, alginates such as carrageenan, agar, etc. and their salts; algin alkyl-carbonates, acetates, propionates and butyrates, etc.; pectins, amylopectin, and derivatives; gelatin; starches and modified starches including alkoxylated forms such as esters, ethers, etc.; cellulose derivatives such as sodium carboxymethylcellulose (CMC), hydroxyethylcellulose (HEC), carboxymethylhydroxyethyl cellulose (CMHEC), ethylhydroxyethyl cellulose (EHEC), methylcellulose (MC), etc.; casein and its derivatives; xanthomonas gums; dextrans of low molecular weights; and guar gums.

Synthetically derived organic types of suspending agents, also suitable for various embodiments of the present invention, include, but are not limited to, acrylic acid or methacrylic acid, and their metallic salts, esters, amides and/or polymers of any or all of these forms; copolymers of acrylic/methacrylic acids and/or their metallic salts, esters, amides, and/or polymers of any or all of these forms; organic amines, amides and polyamides; vinyl polymers such as substituted vinyls, vinyl ester polymers, etc.; metallic stearates especially of aluminum and zinc; castor oil derivatives; polyalkoxylated glycol ethers of high molecular weight; and amine salts of polycarboxylic acids (alginates, polyacrylates, glycolates, etc.).

Of course, combinations of the aforementioned suspending agents are within the scope of the present invention, for example, but not limited to, aqueous dispersions of clays thickened with organic ammonium ions. Further suspending capability is also possible through introduction of gas bubbles as disclosed in U.S. Pat. No. 4,824,590, entitled “Thickened aqueous compositions with suspended solids,” to Roselle, issued Apr. 25, 1989, which is incorporated herein by reference.

Overall, compositions of various embodiment, when in liquid form, contain from about 0.1% to about 20%, preferably from about 0.3% to about 15%, most preferably from about 0.5% to about 5% of suspending agent. Dry compositions of the present invention optionally comprise suspending agent from about 0.25% to about 20% by weight, preferably about 0.75% to about 15%, and most preferably from about 1.5% to about 10% by weight.

Thixotrophic. Thixotrophic is a rheological characteristic wherein, for example, a suspension of clay in water remains relatively rigid until disturbed by vibration. Upon vibration, the suspension liquefies and flows until the vibration or shaking ceases, then, a gel-like stability is reestablished.

Non-staining. Non-staining, as used herein, means that a liquid humate suspension will not discolor clothing in such a way that it cannot be removed by washing with water containing common detergents.

In one embodiment, settling of material, which may occur in liquid compositions, is reversible through shaking, mixing, and/or air sparging. In most instances, while settling may occur, the settled materials do not pack or cake.

According to one embodiment, liquid compositions of the present invention are applied to plants and/or soils using a sprayer at full concentration and/or at a diluted concentration. In this embodiment, the compositions do not clog spray nozzles.

In one embodiment, compositions comprise surfactant. For example, a small amount of surfactant is useful to further insure ease of mixing and/or prevention of clogged nozzles. One suitable material comprising surfactant is Yucca extract. Yucca extract is available as a powder, which contains a steroid saponin type wetting agent. According to various embodiments, Yucca extract or extracts from pseudomonad type bacteria are recommended if an “organically approved” surfactant is desired. Various embodiments of the present invention, whether a dry composition or liquid suspension composition, optionally comprise yucca extract or other commercially available surfactants and/or wetting agents.

In yet another embodiment, the present invention comprises a micronized amendment (e.g., oxidized lignite, gypsum, limestone, rock phosphate, etc.) suspension that is suitable for mixing with other materials, including liquids. According to this embodiment, the addition of other materials does not lead to undesirable clogging and/or caking if applied and/or used shortly after mixing the other material with the composition. For example the micronized amendment suspension of this embodiment is optionally mixed with various ammonium polyphosphate solutions and applied in a band to soils. The micronized amendment suspension helps keep the phosphorus nutrient soluble to plants by complexing the phosphorus and contributing some acidity to the mix. Of course, embodiments comprising dry compositions mixed with other materials, are within the scope of the present invention.

According to a method of applying compositions of the present invention, application pressures starting at approximately 20 psi are typically sufficient to overcome suspension thixotrophy. The suspension thixotrophy is somewhat analogous to a friction force that needs to be overcome before, for example, an object slides down a surface. Thus, application pressures of approximately 20 psi are typically sufficient to get the flow started in a sprayer with, for example, a 0.8 cm diameter hose of 2 meters in length, and an orifice size of approximately 1 mm. As with all liquids, orifice size, hose diameter and length, and presence of additional ingredients (such as ammonium polyphosphate) will affect the pressure needed for good flow and optimum droplet characteristics. Surfactants are also optionally added to effect flow and/or droplet characteristics.

In one embodiment, anticaking additives are not needed, as long as, the dry mix is kept substantially dry (e.g., less than approximately 15% total moisture). In addition, high humidity does not pose a significant problem, because the mix is not prone to absorb enough moisture to effect flowability. If exposure to ambient moisture (rain or drizzle) is anticipated, it is better to cover the mix with a plastic tarp than to try mixing in an anticaking additive. In another embodiment, wherein anticaking and/or flow agents are used, such agents include, but are not limited to, at least one of the following: powdered cellulose, magnesium stearate, stearic acid, paraffin and microcrystalline waxes, polyethylene waxes, mineral and other lubricating oils, talc, silicone dioxide, lactose, calcium citrate and combinations thereof. In general, flow agents reduce attractive and/or frictional forces between particles and/or absorb moisture. In some instances, flow agents are known as anti-caking agents and/or desicating agents. Examples of useful flow agents include CAB-O-SIL® (Cabot Corporation, Boston, Mass.) and SYLOID® (W. R. Grace & Co., New York, N.Y.).

Compositions according to various embodiments of the present invention optionally comprise one or more other materials that are optionally micronized prior to addition. Such materials include, but are not limited to, naturally occurring materials. Naturally occurring materials include, but are not limited to, kelp (a source of micronutrients, trace elements and plant growth hormones), volcanic ash (a source of nutrients and trace elements), rock phosphate (a source of phosphorus), limestone or marl (source of calcium and acidity neutralizer), gypsum (source of calcium), dolomite (a source of magnesium, calcium and acidity neutralizer), mixed rock dust (a source of micronutrients and trace elements), wood ash (source of nutrients and acidity neutralizer) elemental sulfur (also an acidifier), and other humates (sources of humic and fulvic acids).

According to one embodiment, the present invention comprises an organic composition for use as an acidifier and/or pH buffer in hydroponic systems. The main pH problem encountered in hydroponic systems is high pH that develops from plant removal of nutrients like nitrate and phosphate from the hydroponic solution, and from the addition of hard water. High-quality oxidized ignites, for example, have a native pH of about 3.6, and an ion exchange capacity of 300 to 600 cmol (+) charge per kilogram. The buffering range of oxidixed lignites extends from pH 3.2 to about 8.5.

According to another embodiment, the present invention comprises a micronized humate suspension, comprising a pH very close the native humate (pH 3.6 for high analysis oxidized lignite suspension), and a total humic and fulvic acid content of at least approximately 12% by weight to at least approximately 24% by weight. The composition of this embodiment optionally comprises all-natural ingredients and easy handling characteristics including, but not limited to, non-staining. Commercially available liquid humate products are notorious for their staining ability.

Another embodiment of the present invention comprises a suspension formed by adding water to an inventive dry composition. For example, a liquid suspension is formed by adding approximately 405 g of a dry composition to approximately 735 ml of water, for a final volume of approximately one liter, with a density of approximately 1.14 g/ml or 9.12 lb per gallon. This liquid composition and/or the dry composition are saleable to end users and/or the trade. Where a dry composition is sold to the trade, the retailer optionally adds water to the dry composition and sells the resulting liquid composition to the end user, which may be applied directly or further diluted and/or mixed with other materials.

Dry compositions and/or liquid compositions of the present invention are optionally made through a process involving fine grinding of raw soil and/or plant amendment (e.g., oxidized lignite) to a particle size less than approximately 50 microns. The finely ground, or micronized, amendment is then combined with ground attapulgite, as a suspending agent, at approximately 1.5% by weight (based on a final water diluted, i.e., liquid, formula). According to this embodiment, the attapulgite comprises a size of less than approximately 325 mesh (44 microns, 0.0017 inch). The resulting mix comprises a viscosity of greater than or equal to approximately 1000 centipoises and is thixotrophic. While this composition, in liquid form, exhibits some degree of settling over time, re-suspension is possible with minimal energy input. For example, a one-liter bottle was shaken gently by hand to re-suspend the contents thereof. Furthermore, no residue (other than a thin layer of homogeneous suspension coating the entire bottle) adhered to the bottom, which is typically a sign of compact settling that is not easily reversed through gentle shaking.

As discussed herein, liquid compositions that prevent clogging of sprayers and/or sprinkler heads are preferred. The example composition of the aforementioned embodiment, in liquid form (405 g dry composition with a suspending agent at approximately 1.5% by weight added to 735 ml water), when tested, did not clog spray or sprinkler systems. In general, the composition, in liquid form, of this example comprises concentrated humate and can be used like any commercially available liquid humate product, and it also comprises humin, which holds water and helps prevent leaching of nutrients in soil.

The liquid composition of the example of the aforementioned embodiment (405 g dry composition/735 ml water) comprises approximately two to approximately four times more humic and fulvic acids when compared to commercially available liquid humate products. Furthermore, it contains humin, no harsh chemical extractants; its humate is unaltered except for size; it adheres to criteria used for organic certification; and it is much safer (toxicity, corrosive, staining potential) to use than commercially available liquid humate products. In addition, the example of the aforementioned embodiment has a pH very close to the native pH of the humate source, and it comprises a lower content of soluble salts than liquid humate produced through alkaline salt extracts. Toxic effects on humans, animals, soils and plants from spillage of the undiluted material are essentially nonexistent. Toxic effects from the unintentional ingestion of small amounts of this material are also essentially nonexistent.

According to an embodiment of the present invention, micronized amendment is made using raw oxidized lignite (containing approximately 70% humic plus fulvic acids by weight), which is, for example, mined and subsequently milled to approximately 0.25 in (0.63 cm) or less. Next, approximately 15 kg of attapulgite clay is added per approximately 1000 kg of micronized amendment and mixed until substantially uniformly dispersed. The combined material is then ground, if necessary, to a size of 100% less than approximately 50 microns. This product is shipped to the trade. In another embodiment, Min-U-Gel 400 suspending clay, which is rated as 100% passing a 325 mesh screen (about 44 microns), is used, which ground further after mixing with an amendment, e.g., oxidized lignite.

According to an embodiment of the present invention, a substantially dry composition of at least one amendment and suspending agent are mixed with water. For example, the following procedure is suitable to form a liquid suspension from a dry composition.

1. Provide dry composition comprising micronized amendment and micronized suspending agent;

2. Provide softened water;

3. Slowly add approximately 3.24 lbs of the dry composition to approximately 94.1 ounces water (approximately 0.39 kg of the dry composition to approximately 750 ml of water) while stirring, aerating or agitating the mixture. This will make approximately one gallon of liquid amendment concentrate.

4. Continue mixing for approximately 2 to 4 minutes for small batches (less than 10 liters), and approximately 10 to 20 minutes for very large batches (more than 1000 liters).

A storage container for large quantities of the liquid composition optionally comprises a mixer and/or an air sparger, alternatively, it can be shaken, rolled or inverted prior to use. Although only a minimal amount of settling is expected, mixing can ensure that the micronized humate is uniformly distributed in composition.

In general, the composition comprises a low pH, wherein the low pH together with the highly oxidized state of lignite inhibits growth of bacteria and most fungi. However, it is still possible that some acid-tolerant fungi may grow during long-term storage of the liquid product. Thus, if long term storage is anticipated, an amount of food-grade hydrogen peroxide can be added to get peroxide levels up to or above 30 ppm (30 mg per kg), which is a generally accepted food industry standard. For example, about one liter of 30% peroxide per 4000 liters is typically sufficient, or, for the end user making the suspension from the powder, about three teaspoons of fresh 3% peroxide per gallon (3 ml per liter) of final liquid concentrate. Peroxide treatment can be optionally repeated on a monthly basis. Of course, other growth inhibitors or retardants may be used, but a case-by-case determination may be necessary for some inhibitors/retardants when organic certification is desired.

According to various embodiments of the present invention, special application procedures are generally unnecessary. For example, application of liquid compositions may be achieved through commercially available spraying equipment, or the composition may be injected into an irrigation stream. Of course, nozzle size should not be a concern for use with commercially available spray equipment for agricultural, horticultural or home use. When equipment is subsequently used for other chemicals, a flushing out of spray and/or irrigation equipment with water is generally sufficient to remove any residue.

In one embodiment, all ingredients are non-toxic such that ingestion of small amounts of the liquid composition does not present a hazard or emergency situation. The only known hazard from exposure to the dust is irritation to the eyes and may be inhaled. Use of a mask and goggles is advised if long-term exposure to the dust is anticipated.

According to one embodiment, the present invention comprises only a micronized oxidized lignite, a suspending agent and water wherein the composition has a salt index less than any commercially available liquid humate product wherein the acid humate source is reacted with a salt or a basic extractant and consequently, the resultant solution contains humic and fulvic acid and their salts.

In one embodiment, a liquid composition comprising micronized oxidized lignite has an acidic pH that helps to solubilize phosphorus and micronutrient metals in neutral to alkaline soils.

Because of the higher analysis of humic and fulvic acids in the micronized suspended product, according to various embodiments, more humate can be concentrated in a liquid fertilizer band, compared to liquid extracts of humates. This also helps to solubilize and keep soluble phosphorus and metal micronutrients.

In general, as described herein, high surface area of micronized amendments particles is optionally used to aid in rapid dissolution and reaction with soil particles, microorganisms and plants, when applied to soils. In an Example presented herein, below, trials using a soil application of the micronized suspended product showed an overall effect on plant growth that exceeded an equivalent mass of soil-applied solid humate.

Research reports, known to one of ordinary skill in the art, indicate that dry humates, when applied to soils in sufficient quantities, beneficially affect soil properties; such as increasing nutrient availability in soils and stimulating soil microorganisms. In sufficient quantities, dry humates also enhance soil aggregation (by cationic bridging between soil particles, using humic acids and humin as the “glue”), which in turn increases aeration, water infiltration and percolation, and reducing runoff and erosion by water or wind. Better soil aggregation also allows plant roots to explore soil for water and nutrients. This, in turn, gives the plant better tolerance to nutrient stress and drought. Liquid compositions, according to various embodiments of the present invention, are optionally applicable at a rate of approximately 13 gallons per acre (120 liters per hectare) with a density of approximately 1.14 g/cm³, containing approximately 35% oxidized lignite by weight, of an approximately 70% extractable humic and fulvic acids content will apply an amount of humic and fulvic acids equivalent to an approximately 40 lb per acre (45 kg per ha) addition of oxidized lignite of approximately 70% extractable humic plus fulvic acids content. This rate is of significance because research with crops at several locations in the US using approximately 40 lb per acre (45 kg per ha) of such acid equivalents showed consistent benefits.

Various compositions of the present invention may be applied to soils directly, or sprayed on plants and soil with existing irrigation or spray equipment. Some compositions may also find use in horticulture, where they can be applied to greenhouse media and/or sprayed on plants directly, in addition, some compositions are applicable to plants or soil in vegetable production and nurseries.

Various compositions are also suitable for application to trees, lawns and gardens, parks, athletic grounds, and golf courses. Compositions according to various embodiments are also suitable for use in hydroponics as, for example, as a plant stimulant, a buffer to correct for high pH from hard water or fertilizers, and/or to keep phosphate and metal micronutrients from settling out.

According to one embodiment, the optimal concentration of humate materials is approximately 35% by dry weight for raw oxidized lignite containing approximately 70% humic and fulvic acids by weight. In one embodiment, described herein, good liquid stability was attained with an approximately 1.5% concentration of attapulgite clay having a size of approximately 100% less than 325 mesh (44 microns).

According to another embodiment of the present invention, finely ground, oxidized lignite is suspended into water containing attapulgite clay as the suspending agent. The suspension settles very slowly (over several weeks) and, if necessary, the composition is easily re-suspended by shaking. Humic and fulvic acids in this suspension, which comprise approximately 35% by weight, are from raw oxidized lignite material. In other words, this composition comprises micronized, oxidized lignite, which comprises at least approximately 70% humic and fulvic acids by weight. Thus, the actual content of humic and fulvic acids in this particular embodiment is at least approximately 24% by weight.

According to one embodiment, a liquid composition comprises at least one amendment at approximately 35% by weight, such amendments collectively or individually comprising approximately 70% humic and fulvic acids by weight. Good liquid stability of an amendment was attained with an approximately 1.5% by weight of an attapulgite clay having a particle size less than approximately 325 mesh (44 microns). According to this embodiment, when the composition comprises oxidized lignite, the moisture content of the micronized oxidized lignite is less than about 10% and typically about 5%. Moisture present in the original oxidzed lignite (e.g., 12% to 16%) is optionally driven off from heat generated in the micronizing (grinding) process. Thus, according to one embodiment, adjusting for an oxidized lignite moisture content of 10%, and the addition of approximately 1.5% suspending agent in the micronized powder, a composition comprising approximately 38.5% of micronized oxidized lignite of approximately 70% grade will deliver at least approximately 24% humic and fulvic acids by weight in the final liquid suspension. This high concentration of approximately 24% humic and fulvic acids is beyond that available in commercially available liquid products.

Industrial Applicability:

The invention is further illustrated by the following non-limiting examples.

### EXAMPLE 1

General Compositions

According to an embodiment of the present invention, a variety of suspending agents, including attapulgite, montomorillonite, hectorite, tragacanth, etc. were evaluated. All of these materials exhibited some degree of suspending capability. In particular, ground attapulgite exhibited good suspending characteristics (suitable suspending viscosity and thixotrophic behavior) at concentrations less than approximately 10% by weight in water. Compositions comprising various levels of attapulgite clay in water were examined. The influence of attapulgite particle size on rheology was also examined.

Next, compositions comprising various levels of micronized oxidized lignite (humate) were examined, with particular note of packing and/or thickening. Again, according to some embodiments, packing can detrimentally affect re-suspension of lignite in a composition.

A composition comprising potassium hydroxide humate liquid (about 9% humic and fulvic acids) was made as a carrier for micronized humate. It was determined that either the alkalinity of the liquid or the presence of dissolved humate had a negative impact on suspension of the lignite.

A variety of tests were performed using compositions according to various embodiments of the present invention. In particular, tests were performed to compare the performance of micronized amendments, particularly micronized oxidized lignite, to the traditional solid and liquid products available. Plant and soil samples were sent to a lab for analysis and a statistical analysis of experimental and lab data was performed. An analysis of data from these tests showed the utility of a variety of compositions of the present invention.

### EXAMPLE 2

Making A Specific Composition

The following Example describes, in a non-limiting fashion, an embodiment of the present invention in more detail. As described, the composition of Example 2 comprises: a suspended material, micronized oxidized lignite comprising approximately 34.3% of the total invention by weight; a suspending agent, ground attapulgite clay (particle size of less than approximately 325 mesh or 44 microns) comprising approximately 1.5% by weight; and a solvent, water, comprising the balance; approximately 64.2%.

In this Example, the oxidized lignite comprised approximately 70% humic and fulvic acids and was mined from the Fruitland Formation, which is about 40 miles (64 km) southwest of Cuba, New Mexico. The oxidized lignite was subsequently ground to less than or equal to approximately 0.25 in (0.63cm), and further reduced in size, i.e., micronized, to a particle size of averaging approximately 15 microns, with 100% less than 50 microns. The suspending agent, attapulgite clay, was from Floridin Division of ITC Industrials, Inc. This clay was ground to a particle size wherein approximately 99.995% passed through a 325 mesh (44 microns) screen. An approximately 7% solution by weight of this clay in water had a viscosity of about 4,200 centipoises.

The composition of this Example was prepared using raw oxidized lignite, having a density of approximately 1.51 grams per cubic centimeter, as a suspended soil and/or plant amendment. According to Stoke's Law, the settling velocity of a particle with a density greater than water is proportional to the square of the radius of the particle. Thus, fine grinding to a particle size of 100% less than approximately 50 microns was performed using an attrition-type, high-velocity mill, facilitates suspension.

The suspending agent was added to promote thixotrophic behavior and create a viscosity sufficient to suspend the amendment, here, micronized oxidized lignite. As viscosity increases, the settling time also increases; thus, at a high viscosity, dispersed amendment particles will not readily associate and settle out in the form of a flocculation or aggregate. Thixotrophy allows the suspension be easily re-suspended by shaking or stirring and also enhances flow when, for example, pouring the suspension from a container.

### EXAMPLE 3

Use and Performance of Composition

Example 3 consists of comparison between a composition according to an embodiment of the present invention and commercially available products. In this comparison, replicated greenhouse trials were performed to determine the effectiveness of micronized oxidized lignite suspensions on characteristics of plant growth.

A total of 8 trials were performed, using corn, sunflowers, bush snap beans and tall fescue. Each species was planted into two soils; an alkaline soil (IIdefonso gravelly sand loam, located 0.25 km Northwest of the intersection of Interstate 25 and State Route 165 in Sandoval County New Mexico) and an acidic soil (the subsoil horizon (“B Horizon”), a loamy sand, over decomposed granitic parent material located on a ridgetop, at 2450 meters above sea level, in the Cibola National Forest along State Route 165, approximately 2.2 km before it joins with State Route 536). Each of the eight trials were replicated five times. Of these treatments, the five most relevant included:

1. Control—no amendment added (in the Figures, “Control”);

2. Foliar application of 1 gallon per acre (9.5 liters per hectare) of 6% oxidized lignite at pH 9.4. This application was repeated three times at 10 day intervals, starting two weeks after emergence (in the Figures, “Liquid Fol”);

3. Foliar application of 1 gallon per acre (9.5 liters per hectare) of 37% by weight micronized oxidized lignite (containing 70% by weight humic and fulvic acids) suspension. This application was repeated three times at 10 day intervals, starting two weeks after emergence (in the Figures, “Micro Fol”);

4. Soil application of 250 lb per acre (280 kg per hectare) of graded humate, containing 70% by weight humic and fulvic acids, screened to a particle size of approximately 1 to 2 mm (0.04″ to 0.08″). (in the Figures, “Greens Gr.”); and

5. Soil application of enough 34.3% micronized oxidized lignite suspension (containing 70% by weight humic and fulvic acids) to provide the equivalent of 250 lbs. per acre (280 kg per hectare) of raw oxidized lignite containing 70% by weight humic and fulvic acids (in the Figures, “Micro Soil”).

Each treatment received equal quantities of Peter's 20-20-20 plus Mircronutrients brand fertilizer prior to planting. Each treatment was replicated 5 times per trial in a completely randomized design. Notes on emergence and growth characteristics were recorded. Composite soil samples for each treatment were taken and analyzed for soil fertility and chemical parameters relevant to plant growth. Plant tissue samples were also taken and analyzed for nutrients. From the data, total uptake for each nutrient element in each treatment was calculated. At the end of the treatment period, whole aboveground plant materials were harvested, dried and weighed. In addition, roots were harvested, cleaned of soil material and weighed fresh.

The relevant measures regarding the performance of the suspended micronized amendment liquids on soils and plant include: Top weights (dry biomass basis); Root mass (fresh); Uptake of Nitrogen, Phosphorus, Potassium, Calcium, Magnesium, Sulfur, Iron, Manganese, Zinc, Copper, Molybdenum, and Boron; Total uptake of all nutrients; Soil pH; Percent organic matter; and Cation Exchange Capacity.

Data show that soil applied micronized oxidized lignite suspension resulted in increased top weights, root mass and total nutrient uptake compared to the control, and to an equivalent amount of well sorted raw oxidized lignite (greens grade). These results are further disclosed with reference to the Figures.

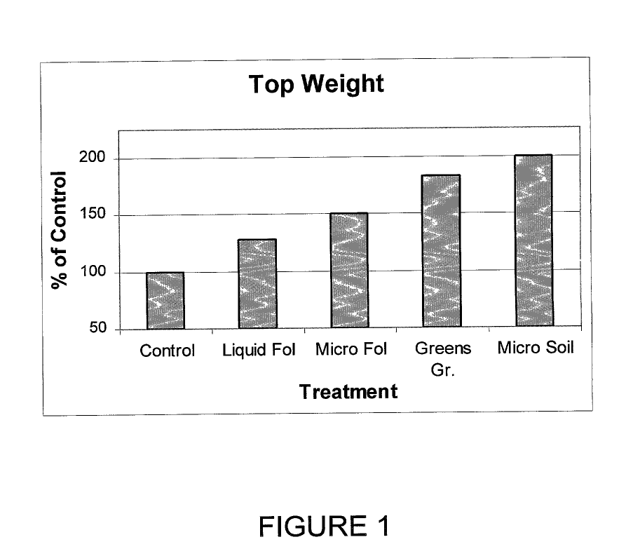

Referring to FIG. 1, a plot of top weight is shown as % of Control versus treatment. The Liquid Fol (liquid foliar) treatment is representative of commercially available products. A comparison of the Liquid Fol and Micro Fol (micronized suspension applied foliar) treatments shows that the inventive composition resulted in a greater top weight, almost 25% greater than that of the Liquid Fol treatment, and about 50% greater than the control.

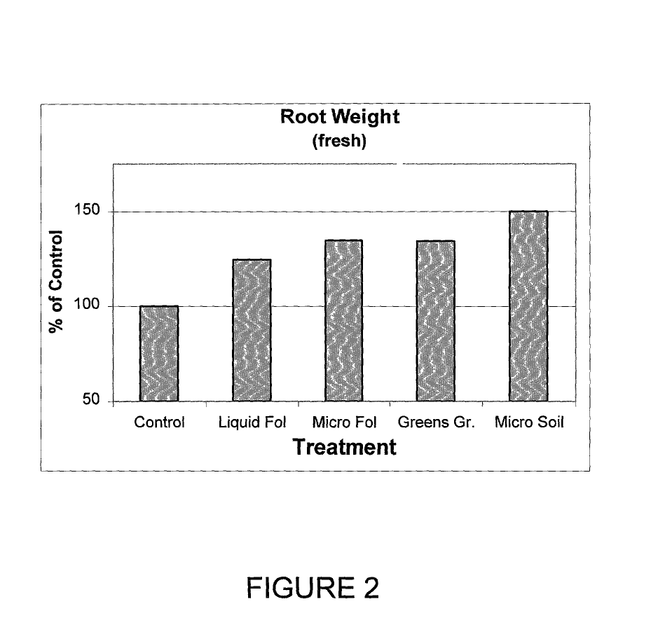

Referring to FIG. 2, a plot of fresh root weight is shown as % of Control versus treatment. The Liquid Fol treatment is representative of commercially available products. A comparison of the Liquid Fol and Micro Fol treatments shows that the inventive composition resulted in a greater fresh root weight, over 10% greater than that of the Liquid Fol treatment.

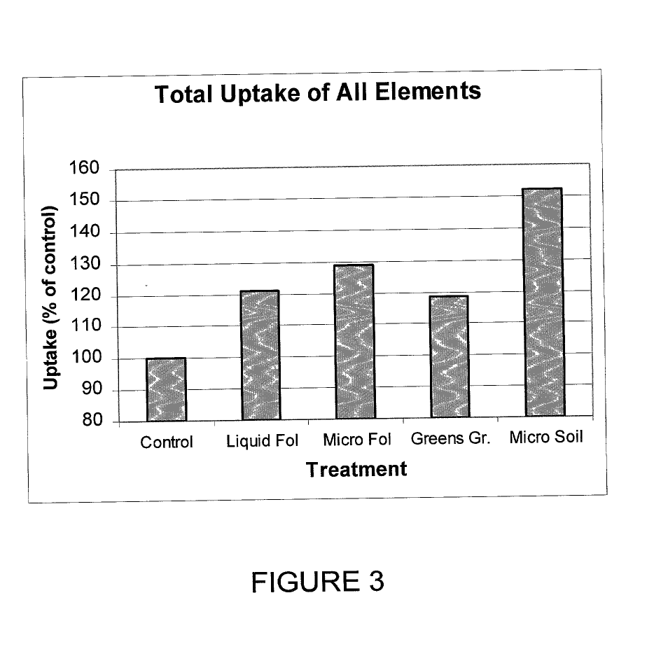

Referring to FIG. 3, a plot of total uptake of all elements is shown as % of Control versus treatment. The Liquid Fol treatment is representative of commercially available products. A comparison of the Liquid Fol and Micro Fol treatments shows that the inventive composition resulted in a greater uptake of all elements, almost 10% greater than that of the Liquid Fol treatment and about 25% greater than the control.

TABLE 1
below, shows a breakdown of the data presented in FIG. 3. Numbers are
expressed as a percentage of the control for that element.

| Element | Control | Liquid Fol | Micro Fol | Greens Gr. | Micro Soil |
|---|---|---|---|---|---|
| N | 100 | 126.5 | 126.6 | 126.2 | 174.8 |
| P | 100 | 138.2 | 136.6 | 128.7 | 180.3 |
| K | 100 | 125 | 131.7 | 120 | 159.3 |
| Ca | 100 | 123.5 | 115.4 | 116.8 | 144.9 |
| Mg | 100 | 133.5 | 132.9 | 128.8 | 165.9 |
| S | 100 | 123.5 | 125 | 123.3 | 170.2 |
| Fe | 100 | 115.1 | 150 | 118.1 | 153.6 |
| Mn | 100 | 111.8 | 118.5 | 112.2 | 134.5 |
| Zn | 100 | 109.2 | 110.9 | 112.4 | 132.2 |
| Cu | 100 | 112.5 | 109.7 | 108.2 | 137.8 |
| B | 100 | 119.3 | 118.4 | 114.2 | 134.6 |
| Macro | 100 | 128.4 | 128 | 123.9 | 165.9 |
| Micro | 100 | 113.6 | 129.9 | 113 | 138.5 |
| Total | 100 | 121 | 128.9 | 118.5 | 152.2 |

Overall, foliar application of micronized oxidized lignite (Micro Fol) resulted in increased top weights, root mass and total nutrient uptake when compared to the control (Control) and to an equivalent volume of base-extracted liquid humate (Liquid Fol).

The superior performance of soil applied micronized oxidized lignite over soil applied raw oxidized lignites (humates) is potentially due to at least one of the following factors:

1. More effective distrubution and dispersion the micronized oxidized lignite throughout the soil matrix;

2. Increased dissolution rate and more rapid establishment of equilibrium with the soil solution and solid soil phases, due to the greatly increased unit surface area of the micronized oxidized lignite.

3. This (factor 2), in turn, results in a shorter interval between the application of the micronized oxidized lignite suspension to the soil, and the beginning of uptake of the dissolved humate by plant roots and soil microbes, resulting in an increased metabolic activity by both.

4. Factor 2 results in a shorter interval between the application of the micronized oxidized lignite suspension to the soil, and the beginning of dissolution of bound soil nutrients and their complexation with humic and fulvic acid molecules.

The superior performance of foliar applied micronized oxidized lignite (Micro Fol) over foliar applied base extracted humate solution (Liquid Fol) is potentially due to at least one of the following factors:

1. More humic and fulvic acids per gallon of micronized oxidized lignite than contained in traditional base extracted liquid humate; and

2. Oxidized lignite particles slowly dissolve and release humic and fulvic acids over a longer period, compared to an application of traditional base-extracted dissolved liquid humate.

There were no observed statistically significant differences between the control and all treatments on soil chemical and physical properties measured by standard means. The relatively short, eight to twelve week duration of each trial, combined with excess watering of the pots possibly minimized differences that may have accumulated. However, increased uptake of nutrients by plants in all experiments provides indirect evidence of increased nutrient availability and/or the stimulation of uptake by plant roots. The data in Table 1 is useful to compare the total uptake of each element to the control (no oxidized lignite added). All treatments for each experiment received equal amounts of fertilizer nutrients before the start of the trial.

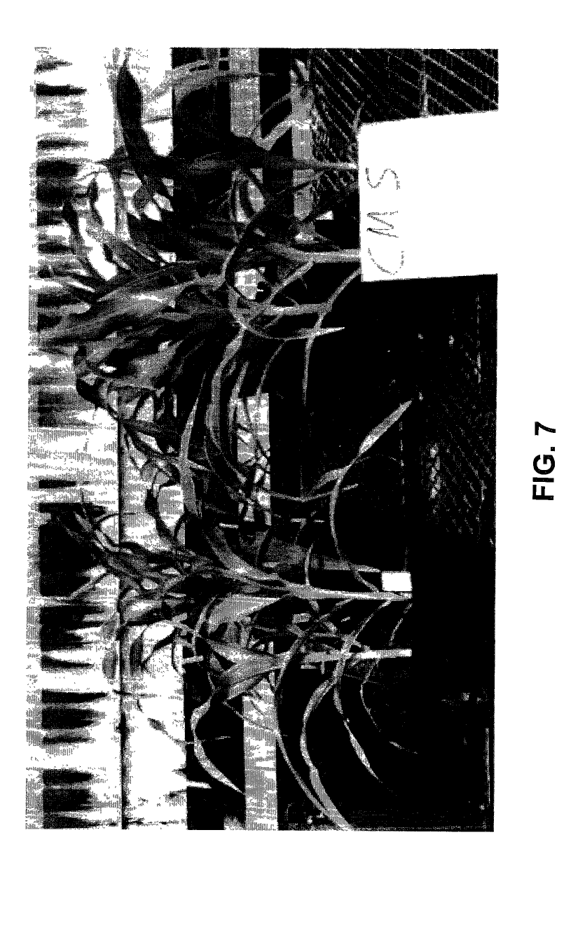

Results from the trials are further demonstrated in FIGS. 7 through 10. Referring to FIG. 7, a photograph of corn is shown for comparing the soil application of enough micronized oxidized lignite suspension to provide the equivalent of approximately 280 kg per hectare of raw humate containing approximately 70% by weight humic and fulvic acids (seen on the right as CMS), to the control (left). Note the taller corn plants and the deeper green color (seen as a darker shade in the black and white photograph) of the plants at right.

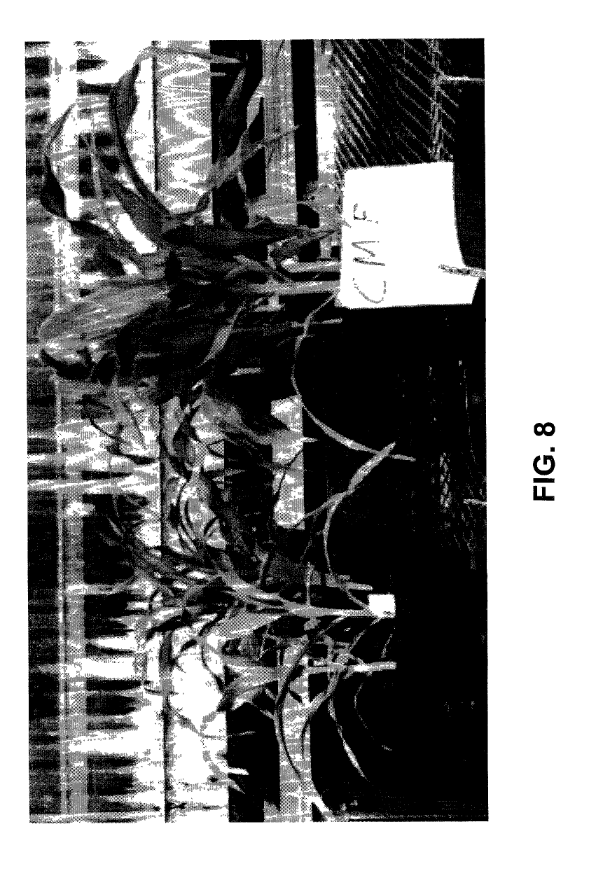

Referring to FIG. 8, a photograph of corn is shown for comparing the foliar application of approximately 9.5 liters per hectare of 37% by weight micronized oxidized lignite suspension (seen on the right as “CMF”), to the control (left). This application was repeated three times at approximately 10 day intervals, starting two weeks after emergence. The treated corn plants at right are taller, with broader leaves and thicker stems.

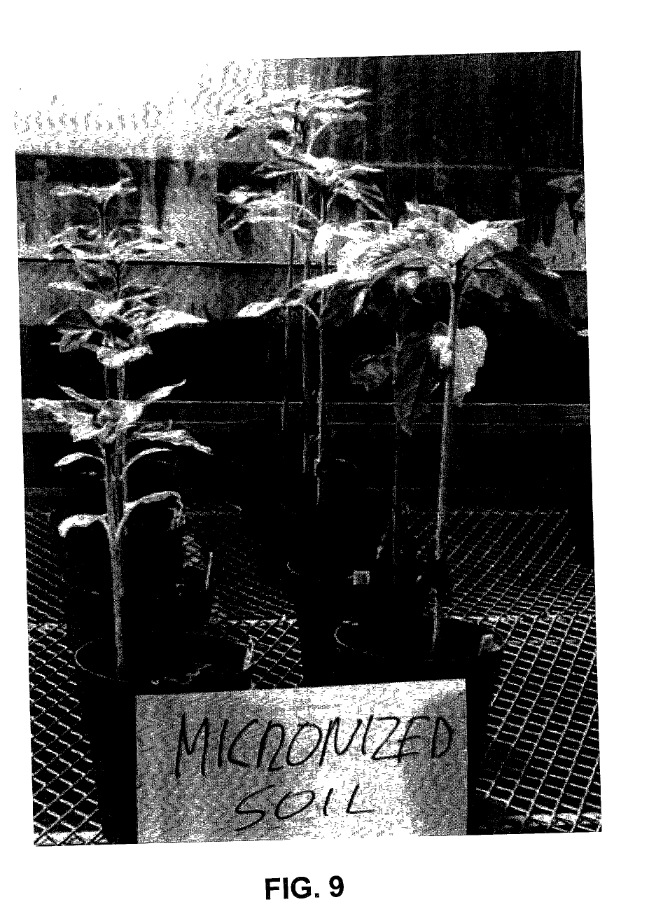

Referring to FIG. 9, a photograph of sunflowers is shown for comparing the soil application of enough micronized oxidized lignite suspension to provide the equivalent of 280 kg per hectare of raw humate containing 70% by weight humic and fulvic acids (right) to the control (left). Note the taller sunflower plants and thicker stems on the right.

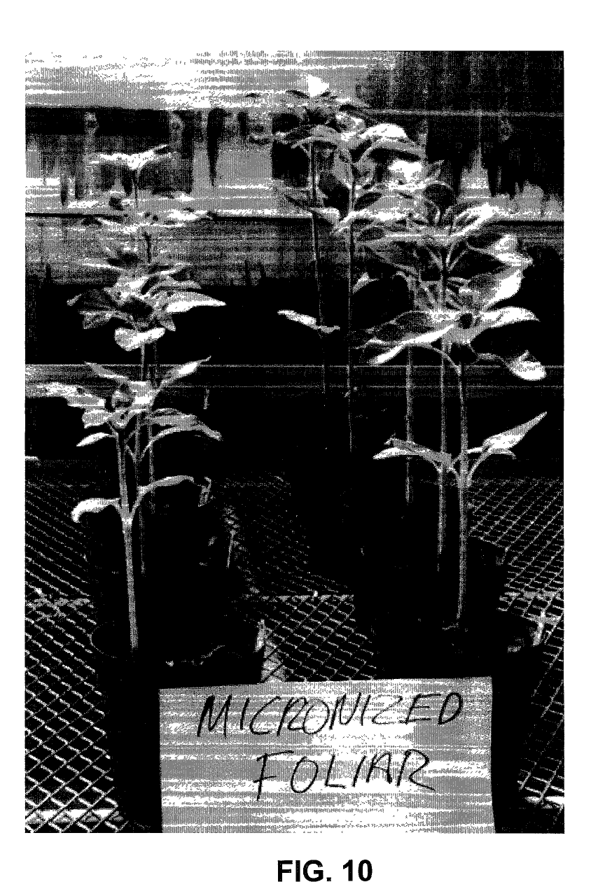

Referring to FIG. 10, a photograph of sunflowers is shown for comparing the foliar application of 9.5 liters per hectare of 37% by weight micronized oxidized lignite suspension (seen on the right as “CMF”), to the control (left). This application was repeated three times at 10 day intervals, starting two weeks after emergence. The oxidized lignite treated plants are taller and have thicker stems.

### EXAMPLE 4

Use and Performance of Compositions Comprising other Amendments

The trials outlined above in Example 3 are repeated for other amendments, alone or in combination with other amendments. Such amendments include, but are not limited to, micronized gypsum, micronized limestone, and micronized rock phosphate. Methods of making are as those outlined in aforementioned Examples, and/or as described elsewhere herein or as suitably known to one of ordinary skill in the art. As for all embodiments, in some instances, an amendment is optionally found micronized in its natural state; thus, a “micronizing” step is optionally omitted. Results show beneficial effects on plants and/or soils.

### EXAMPLE 5

Gypsum as Amendment

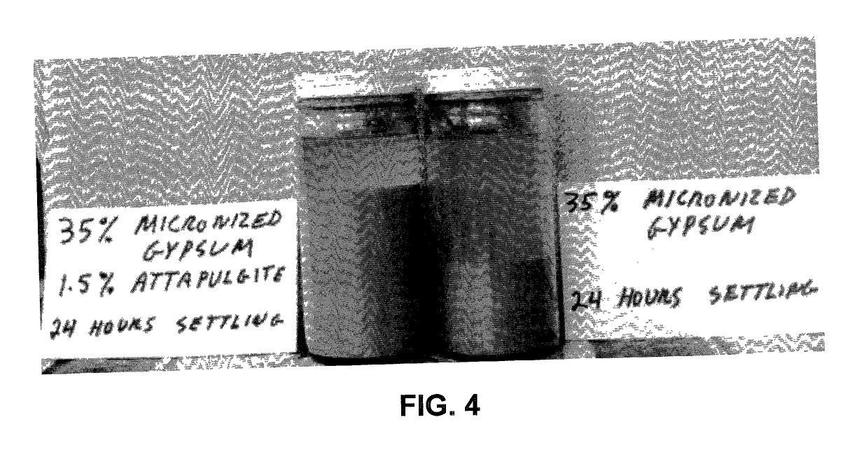

Referring to FIG. 4, a photograph is shown for comparing a suspension of 35% micronized gypsum by weight, with 1.5% attapulgite clay suspending agent (left side), to a liquid containing the same amount of micronized gypsum, but without the addition of the suspending agent (right side), taken 24 hours after mixing. Although some settling has occurred, as expected, there is still nearly twice the volume of the liquid occupied by the micronized gypsum plus suspending agent, compared to the gypsum alone. Because of this, resuspension by stirring or shaking is easily done.

### EXAMPLE 6

Limestone as Amendment

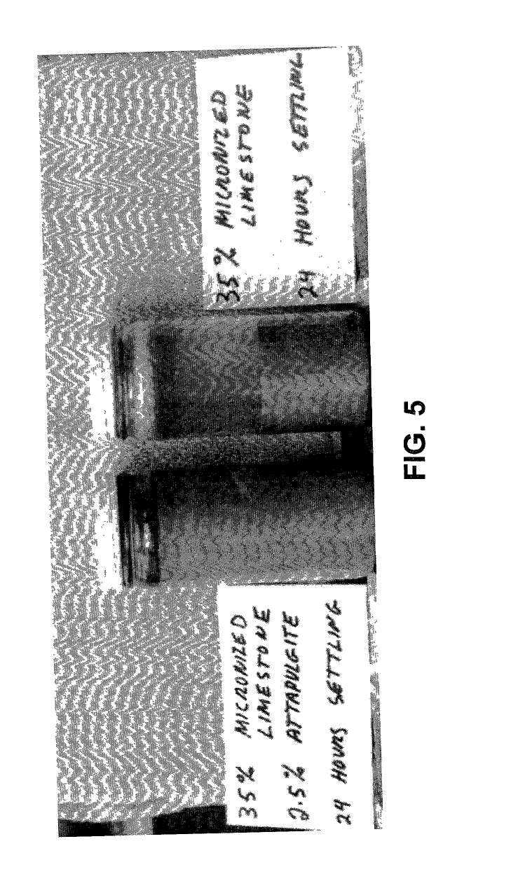

Referring to FIG. 5, a photograph is shown for comparing a suspension of 35% micronized limestone by weight, with 2.5% attapulgite clay suspending agent (left side), to a liquid containing the same amount of micronized limestone, but without the addition of the suspending agent (right side), taken 24 hours after mixing. Minimal settling has occurred because of the higher amount of suspending agent added to the micronized limestone (compared to the gypsum (1.5%) as shown in FIG. 4). The much greater volume of the liquid occupied by the micronized limestone plus suspending agent, compared to the micronized limestone alone, allows for quick resuspension by stirring, shaking or air sparging.

### EXAMPLE 7

Rock Phosphate as Amendment

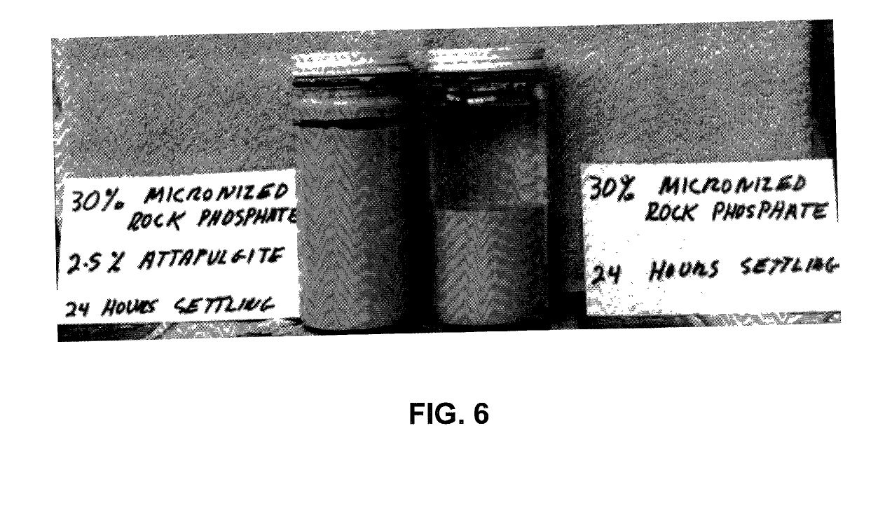

Referring to FIG. 6, a photograph is shown for comparing a suspension of 30% micronized rock phosphate by weight, with 2.5% attapulgite clay (left side), to a liquid containing the same amount of micronized rock phosphate, but without the addition of the suspending agent (right side), 24 hours after mixing. The much larger volume occupied by the micronized rock phosphate plus suspending agent, compared to the micronized rock phosphate alone, allow for rapid resuspension by stirring, shaking or air sparging.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A substantially dry composition for application to plants or soils, said composition comprising:
at least one micronized amendment; and
a suspending agent.

2. The composition of claim 1 wherein said at least one micronized amendment comprises oxidized lignite.

3. The composition of claim 1 wherein said at least one micronized amendment comprises at least one amendment selected from the group consisting of gypsum, limestone and rock phosphate.

4. The composition of claim 1 wherein said suspending agent comprises attapulgite clay.

5. The composition of claim 1 where said suspending agent comprises an agent that forms a thixotrophic suspension when mixed with water.

6. The composition of claim 1 wherein said at least one micronized amendment comprises organic material.

7. The composition of claim 1 wherein said suspending agent comprises organic material.

8. The composition of claim 1 wherein said at least one micronized amendment and said suspending agent each consist of organic material.

9. The composition of claim 1 further comprising at least one surfactant.

10. The composition of claim 9 wherein said at least one surfactant comprises Yucca extract.

11. A suspension for application to plants or soils, said suspension comprising:
at least one micronized amendment;
a suspending agent; and
water, wherein said water, said at least one micronized amendment and said suspending agent form a suspension.

12. The suspension of claim 11 wherein said at least one micronized amendment comprises oxidized lignite.

13. The suspension of claim 11 wherein said at least one micronized amendment comprises at least one amendment selected from the group consisting of gypsum, limestone and rock phosphate.

14. The suspension of claim 11 wherein said suspending agent comprises attapulgite clay.

15. The suspension of claim 11 where said suspending agent comprises an agent that forms a thixotrophic suspension when mixed with water.

16. The suspension of claim 11 wherein said at least one micronized amendment comprises organic material.

17. The suspension of claim 11 wherein said suspending agent comprises organic material.

18. The suspension of claim 11 wherein said at least one micronized amendment and said suspending agent each consist of organic material.

19. The suspension of claim 11 further comprising at least one surfactant.

20. The suspension of claim 19 wherein said at least one surfactant comprises Yucca extract.

21. A method of making a substantially dry composition capable of forming a liquid suspension for application to plants or soils, the method comprising the steps of:
providing an amendment;
providing a suspending agent; and
micronizing the amendment and the suspending agent.

22. The method of claim 21 wherein the amendment comprises oxidized lignite.

23. The method of claim 21 wherein the amendment comprises at least one amendment selected from the group consisting of gypsum, limestone and rock phosphate.

24. The method of claim 21 wherein the suspending agent comprises attapulgite clay.

25. The method of claim 21 wherein the suspending agent comprises an agent that forms a thixotrophic suspension when mixed with water.

26. The method of claim 21 wherein the micronized amendment comprises organic material.

27. The method of claim 21 wherein the suspending agent comprises organic material.

28. The method of claim 21 wherein the amendment and the suspending agent each consist of organic material.

29. The method of claim 21 further comprising the steps of providing and adding to the composition at least one surfactant.

30. The method of claim 29 wherein the at least one surfactant comprises Yucca extract.

31. A method of making a suspension for application to plants or soils, the method comprising the steps of:
providing an amendment;
providing a suspending agent;
micronizing the amendment and the suspending agent to form a micronized mix; and
mixing the micronized mix with water to form a suspension.

32. The method of claim 31 wherein the amendment comprises oxidized lignite.

33. The method of claim 31 wherein the amendment comprises at least one amendment selected from the group consisting of gypsum, limestone and rock phosphate.

34. The method of claim 31 wherein the suspending agent comprises attapulgite clay.

35. The method of claim 31 wherein the suspending agent comprises an agent that forms a thixotrophic suspension when mixed with water.

36. The method of claim 31 wherein the micronized amendment comprises organic material.

37. The method of claim 31 wherein the suspending agent comprises organic material.

38. The method of claim 31 wherein the amendment and the suspending agent each consist of organic material.

39. The method of claim 31 further comprising the steps of providing and adding to the suspension at least one surfactant.

40. The method of claim 39 wherein the at least one surfactant comprises Yucca extract.
